(19) United States
(12) Patent Application Publication
(10) Pub. No.: US 2006/0197641 A1
(43) Pub. Date: Sep. 7, 2006

(54) Magnetizable painting

(76) Inventor: Chen-Liang Fan Chiang, Taipei (TW)

Correspondence Address: BRUCE H. TROXELL, SUITE 1404, 5205 LEESBURG PIKE, FALLS CHURCH, VA, 22041, US

(21) Appl. No.: 11/117,354

(22) Filed: Apr. 29, 2005

Related U.S. Application Data
(62) Division of application No. 11/068,819, filed on Mar. 2, 2005.

(51) Int. Cl. H01F 7/02

(52) U.S. Cl. 335/302

(57) ABSTRACT

A magnetizable painting containing a base painting, a certain amount of magnetizable material added to the base painting and a certain amount of spreading processing aid added to the base painting. The magnetizable material can be barium, strontium, rubidium, cobalt or boron. The spreading processing aid can be gluing agent, anti-sediment agent, wetting agent, defoamer agent or color spreading agent. The mixture is fully stirred to evenly distribute the magnetizable material in the base painting to form the magnetizable painting. The magnetizable painting can be coated on the surface of various substrate materials to form a magnetizable coating. The coating is at least once magnetized to make the magnetizable material in the magnetizable painting become magnetic material, whereby the surface of the substrate material has a magnetically attractive performance for attracting iron-made objects.

This application is a divisional of U.S. Ser. No. 11/068,819 entitled “Magnetizable Painting” filed on Mar. 2, 2005 and currently pending.

### BACKGROUND OF THE INVENTION

The present invention is related to a magnetizable painting which is manufactured at lower cost and can be easily processed and magnetized.

A conventional magnet is made of iron or metal substrate material containing magnetic compositions, such as barium, strontium, rubidium, cobalt and boron. The substrate material is magnetized to have magnetic attraction. Such metal substrate material is rigid, inflexible and heavy. Also, it is hard to process and carry the metal substrate material. Therefore, the use of such metal substrate material is quite limited.

A soft magnet has been developed recently. Ferric oxide powder is added into a complex material which is a mixture of rubber and plastic. The material is at least once magnetized (magnetically aligned). Pulse current passes through a magnetic conductive disc with different magnetized divisions to induce different magnetic poles on the surface of the complex material. Accordingly, a flexible and soft magnet is formed. Such soft magnets can attract each other or attract an iron-made object. The soft magnet made from the rubber and plastic as the base material is flexible and light and is easy to process. Therefore, such soft magnet is widely used. However, in the manufacturing procedure, it is troublesome and complicated to add the ferric oxide powder into the rubber and plastic base material to form the soft magnet. Moreover, when adding the ferric oxide powder into the rubber and plastic base material, the flexibility and strength of the rubber and plastic material will be affected. As a result, the soft magnet tends to break and damage. Also, it is hard to thin such magnet so that the cost is increased.

In addition, the conventional technique for coloring the magnet is still not mature. As a result, in use, it often takes place that the color is detached from the magnet. Therefore, most of the magnets are black. It is therefore tried by the applicant to provide a better measure for coloring the magnet to beautify the appearance thereof.

### SUMMARY OF THE INVENTION

It is therefore a primary object of the present invention to provide a magnetizable painting containing a base painting, a certain amount of magnetizable material added to the base painting and a certain amount of spreading processing aid added to the base painting. The mixture is fully stirred to evenly distribute the magnetizable material in the base painting to form the magnetizable painting. The magnetizable painting can be coated on the surface of various substrate materials to form a magnetizable coating. The coating is at least once magnetized to make the magnetizable material in the magnetizable painting become magnetic material, whereby the surface of the substrate material has the same property as a magnet. By means of the magnetizable painting, it is easier to magnetize the surface of an object. In addition, the magnetizable coating on the surface of the substrate material can be fully thinned to reduce cost. Also, the original strength of the substrate material will not be affected so that it is uneasy to damage the magnetic material.

It is a further object of the present invention to provide the above magnetizable painting in which the spreading processing aid can be a composition of gluing agent, anti-sediment agent, wetting agent, defoamer agent and color spreading agent for enhancing the evenness of the mixture of the magnetizable material. After the magnetizable painting is sprayed onto the surface of the object and magnetized, the magnetizable painting can have evener and more stable magnetic properties.

In the case that a color is directly added to the magnetizable painting, in manufacturing, the magnet can be colored as necessary to beautify the appearance.

The present invention can be best understood through the following description and accompanying drawings wherein:

### BRIEF DESCRIPTION OF THE DRAWINGS

FIG. 1 is a manufacturing flow chart of the magnetizable painting of the present invention; and

FIG. 2 shows that the magnetizable painting of the present invention is sprayed onto the surface of a substrate material.

### DETAILED DESCRIPTION OF THE PREFERRED EMBODIMENT

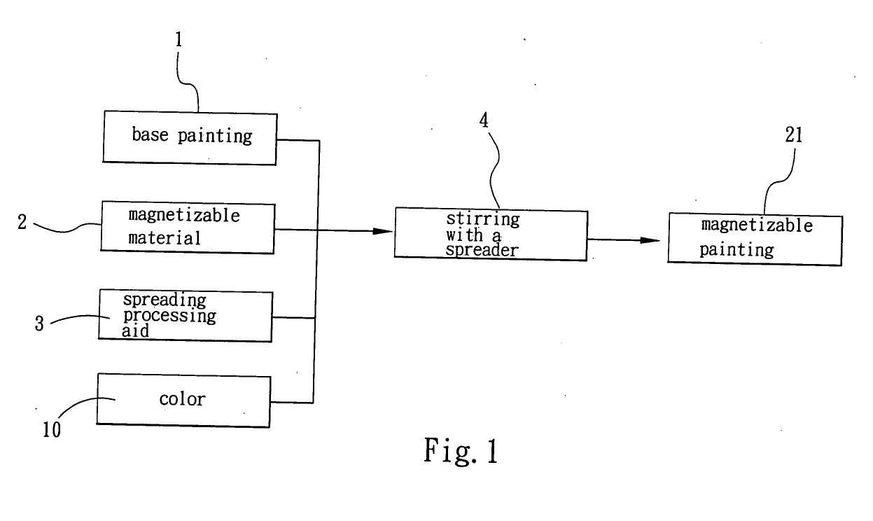

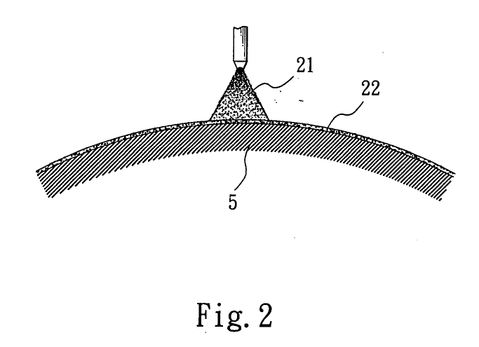

Please refer to FIGS. 1 and 2. The magnetizable painting 21 of the present invention is a mixture of a base painting 1 and a magnetizable material 2. The magnetizable material 2 can be at least one of barium, strontium, rubidium, cobalt and boron or a composition of these magnetizable elements. The magnetizable painting 21 further contains a certain amount of spreading processing aid 3 such as gluing agent (such as glue or resin), anti-sediment agent (such as polyethylene wax), wetting agent (mixture of polymeric carboxylic acid and modified polysiloxane), defoamer agent (such as non-silicone organic compound) and color spreading agent (mixture of polymeric carboxylic acid and modified polysiloxane). The mixture is fully stirred with a spreader 4 such as a roller, a closed spreader, a screener and a high-speed blender. The magnetizable material 2 is evenly distributed in the magnetizable painting 21 without accumulation or sedimentation. The magnetizable painting 21 is coated on an object or a substrate material 5 by a certain spraying measure. After dried and solidified, the magnetizable painting becomes a magnetizable coating 22. Then the coating 22 is at least once magnetized (magnetically aligned). Pulse current passes through different magnetized divisions to induce the coating 22 on the surface of the substrate material 5 into magnetic surface. At this time, the surface of the substrate material 5 has the same property as a magnet.

The magnetizable painting 21 can be sprayed onto the surface of the substrate material 5 with different thickness and evenness according to the pattern of the substrate material 5 and the required color. The magnetizable painting 21 can be painted on the substrate material 5 with a brush, roller, sprayer, halftone printing or scraper.

In addition, when blending the painting, a desired color 10 can be selectively added into the painting to achieve various colors of magnetizable paintings 21. Therefore, the application range of the magnetizable paintings 21 can be widened and more convenient.

By means of the magnetizable painting of the present invention, it is easier to magnetize the surface of an object without limitation of the aspect of the surface. The magnetizable coating 22 on the surface of the substrate material 5 can be fully thinned. The color is directly blended with the painting to color the painting so that the second coloring processing is unnecessary. Also, the shortcoming of detachment of the color is eliminated. Therefore, the utility of the magnet is greatly enhanced and the cost is reduced. In addition, it is easier to process and magnetize the object.

The above embodiment is only used to illustrate the present invention, not intended to limit the scope thereof. Many modifications of the above embodiment can be made without departing from the spirit of the present invention.

1-12. (canceled)

13. A magnetizable paint for a substrate material comprising:
a magnetizable coating material having:
a) a base paint;
b) a magnetizable material; and
c) a spreading processing aid, wherein the base paint, the magnetizable material, and the spreading processing aid are mixed together, the magnetizable material being at least once magnetized, a surface of the substrate having a magnetic attraction.

14. The magnetizable paint according to claim 13, wherein the spreading processing aid is selected from a group consisting of a gluing agent, an anti-sediment agent, a wetting agent, a defoamer agent, a color spreading agent and any combination thereof.

15. The magnetizable paint according to claim 13, wherein the magnetizable material is selected from a group consisting of barium, strontium, rubidium, cobalt, boron, and any combination thereof.

16. The magnetizable paint according to claim 14, wherein the magnetizable material is selected from a group consisting of barium, strontium, rubidium, cobalt, boron, and any combination thereof.

17. The magnetizable paint according to claim 13, further comprising a color mixed with the magnetizable coating material.

18. The magnetizable paint according to claim 14, further comprising a color mixed with the magnetizable coating material.

19. The magnetizable paint according to claim 15, further comprising a color mixed with the magnetizable coating material.

20. The magnetizable paint according to claim 16, further comprising a color mixed with the magnetizable coating material.
